(19) United States
(12) Patent Application Publication
(10) Pub. No.: US 2021/0041058 A1
(43) Pub. Date: Feb. 11, 2021

(54) METHODS AND APPARATUS FOR RAILING CLAMPS

(71) Applicant: Andrew Kenneth Shayler, White Rock (CA)

(72) Inventor: Andrew Kenneth Shayler, White Rock (CA)

(21) Appl. No.: 16/533,788

(22) Filed: Aug. 7, 2019

(51) Int. Cl. F16M 13/02; E04H 12/22; F16B 2/10

(52) U.S. Cl. CPC F16M 13/022; F16B 2/10; E04H 12/2269

(57) ABSTRACT

Apparatus and methods for coupling an item to a mount are disclosed. One such apparatus includes a holder for holding an item. The holder is attached to a first top piece that rests on the mount. A second top piece is attached to the first top piece through a hinge. The hinge is for transferring a first downwards force applied at the holder to an upwards force at a bearing end extending underneath the mount and a second downwards force at a portion of the second top piece and for generating a twisting force on the mount due to one of the portion of the second top piece and the bearing end being closer than the other to an axis that is perpendicular to the second top piece and passes through the hinge when the apparatus is installed on the mount, causing the apparatus to clamp onto the mount.

### TECHNICAL FIELD

The present disclosure relates to clamps, and in particular, clamps for mounting onto railings.

### BACKGROUND

Decks, gardens and backyards have been used for family gatherings and social events for as long as they have been around. A multi-billion dollar industry has grown around decks and yards to produce items for use in decks and yards, including furniture, cookers, and decorative items. Some of the most common items used on decks and in yards include tables and chairs with deck umbrellas, torches, and decorative items such as flags.

Various types of holders for holding umbrellas, torches, flags and other items are available on the market, including both permanently fixed and easily removable types of holders. Additionally, some are stand alone while others are attached to other items or fixtures. Various types of equipment and methods are used to secure the holders in place. For example, stand alone holders are often weighted. Other types of holders may be attached to furniture, walls, or railings, such as deck railings. Some of these may be screwed or bolted in place. Some holders that are available are attachable to the posts and/or balusters of a deck railing. These types of holders may be secured in position using a clamping mechanism. Various types of clamping mechanisms are available, including clamping mechanisms that use bolts, screws and springs.

There exists a continuing desire to advance and improve technology related to deck clamps.

### SUMMARY

According to one aspect, there is provided an apparatus for coupling to a mount that has a first mount side in a spaced apart relationship with a second mount side, the first and second mount sides connected by a mount top and a mount bottom. The apparatus may include a holder for holding an item and a first top piece for resting on a portion of the top of the mount. The first top piece may be coupled to the holder for holding the holder over a side of the mount. The apparatus may also include an end piece comprising a second top piece and a side piece. The second top piece may be adjacent to the first top piece and coupled to the side piece. The side piece may be positioned for extending towards the mount bottom. The apparatus may also include a bottom clamping portion coupled to the side piece for extending along a portion of the mount bottom. The bottom clamping portion may have a bearing end distal to the side piece for bearing against the mount bottom. The apparatus may also include a hinge coupling the first top piece to the second top piece. The hinge may be for transferring a first downwards force applied at the holder to an upwards force at the bearing end and a second downwards force at a portion of the second top piece and generating a twisting force on the mount due to one of the portion of the second top piece and the bearing end being closer than the other to an axis that is perpendicular to the second top piece and passes through the hinge when the apparatus is installed on the mount, causing the apparatus to clamp onto the mount.

The apparatus may also include a second side piece extending down from the first top piece.

The second side piece may be adjustably coupled to the first top piece for moving the second side piece along a portion of the length of the first top piece for fitting the apparatus on mounts of different sizes.

The bottom clamping piece is adjustably coupled to the first side piece for adjusting the position of the bottom clamping piece to position the bearing end against the mount bottom.

The apparatus may also include a second bottom piece coupled to the second side piece at a location closer to the distal end of the second side piece than to the end coupled to the first top piece and positionable adjacent to the mount bottom when the apparatus is installed on the mount, for limiting rotation of the first top piece around the hinge.

The hinge and the bearing end may have an axis that passes through both the hinge and the bearing end and that is perpendicular to the second top piece.

The holder may be sized and shaped to hold a pole.

The first side piece may be adjustably coupled to the second top piece for adjusting the position of the first side piece relative to the top piece.

According to another aspect, there is provided a method for coupling a holder for holding an item to a mount. The method may include exerting an upwards force on a hinge coupling a first top piece and a second top piece of a clamping apparatus, the first top piece also coupled to the holder at an end distal to the hinge, by transferring a force at the holder generated by weights of at least one of the holder, the item and a portion of the first top piece, around a pivot point where the first top piece rests on the mount and to the upwards force pushing against the hinge. The method may also include exerting forces pushing down at a top surface of the mount and up at a bottom surface of the mount by positioning a bearing end of a bottom clamping piece underneath the mount, the bottom clamping piece coupled to the second top piece through a first side piece, such that the upwards force at the hinge pulling on an end of the second top piece causes the second top piece, the first side piece and the bottom clamping piece to experience a first twisting force, causing a portion of the second top piece to push against the top of the mount and the bearing end to push against the bottom of the mount. The method may further include generating a second twisting force acting on the mount by positioning the second top piece and the bearing end such that the portion of the second top piece that pushes against the top is laterally offset from the bearing end with one of the portion of the second top piece and the bearing end being closer than the other to an axis perpendicular to the second top piece and passing through the hinge when the apparatus is installed on the mount, wherein the second twisting force is opposite in orientation to a force moment generated on the mount by the weight at the holder.

The method may also include securing the first top piece from lifting off the mount by positioning a second bottom piece adjacent to the bottom of the mount when the apparatus is in an installed position.

### BRIEF DESCRIPTION OF THE DRAWINGS

In the accompanying drawings, which illustrate one or more example embodiments,

FIG. 1 is a perspective view of an apparatus, according to one embodiment;

FIG. 2 shows a top and a side view of an apparatus, according to one embodiment;

FIG. 3 is a side view of an apparatus with one end lifted;

FIG. 4 is a perspective view of a holder coupled to a side piece; and

FIG. 5 shows a method for clamping a holder to a mount according to one embodiment.

### DETAILED DESCRIPTION

Directional terms such as “top”, “bottom”, “upper”, “lower”, “left”, “right”, and “vertical” are used in the following description for the purpose of providing relative reference only, and are not intended to suggest any limitations on how any article is to be positioned during use, or to be mounted in an assembly or relative to an environment. Additionally, the term “couple” and variants of it such as “coupled”, “couples”, “coupling”, and “couplable” as used in this description are intended to include indirect and direct connections unless otherwise indicated. For example, if a first device is coupled to a second device, that coupling may be through a direct connection or through an indirect connection via other devices and connections. Similarly, if the first device is communicatively coupled to the second device, communication may be through a direct connection or through an indirect connection via other devices and connections. The term “couplable”, as used in the present disclosure, means that a first device is capable of being coupled to the second device. A first device that is communicatively couplable to a second device has the ability to communicatively couple with the second device but may not always be communicatively coupled.

Various types of holders are available for holding umbrellas, tiki torches, flags and other items that are mounted to poles. These holders are generally designed to be stable and hold the item securely. Many types of designs are used to achieve this. For example, many of these holders are weighted to prevent them from falling down, making them heavy and cumbersome. Certain holders are designed to be attached to an external surface or item. For example, some umbrellas are designed to be attached to a table, although additional weights may still be used to secure the umbrella. Screws and bolts may be used to secure holders to walls or posts.

Several types of holders have been designed to be attached to a railing, such as a deck railing. These types of holders may be attached to the spindles of the railing or posts of a railing. Using a railing as a base may be advantageous as a railing is often located in places where one may use an umbrella or tiki torch. Furthermore, railings may provide a strong base for securing a holder.

Often, these holders include screws or other tightening mechanisms to secure the holder to the spindles or posts. Attaching the holder to the railing may be difficult, decreasing the portability of the holder.

The present disclosure provides an apparatus for holding items that clamps onto a mount, such as the top rail of a railing. The apparatus may be portable and may be installed quickly. It may be fitted around a mount and, using a hinge mechanism that hingedly couples two sides of the apparatus across the width of mount, the weight of the item being held may be used to provide an additional clamping force for securing the apparatus and the item being held.

With few parts, the apparatus provides for a holder that may be relatively inexpensive when compared to other types of holders and may be quickly attached or removed without the use of tools. Various types of items may be held. For example, the same apparatus may be used to hold an umbrella, a tiki torch or a flag. Since the weight of the item may contribute to the clamping force of the apparatus, a lighter item may be swapped for a heavier item without compromising the clamping ability of the apparatus.

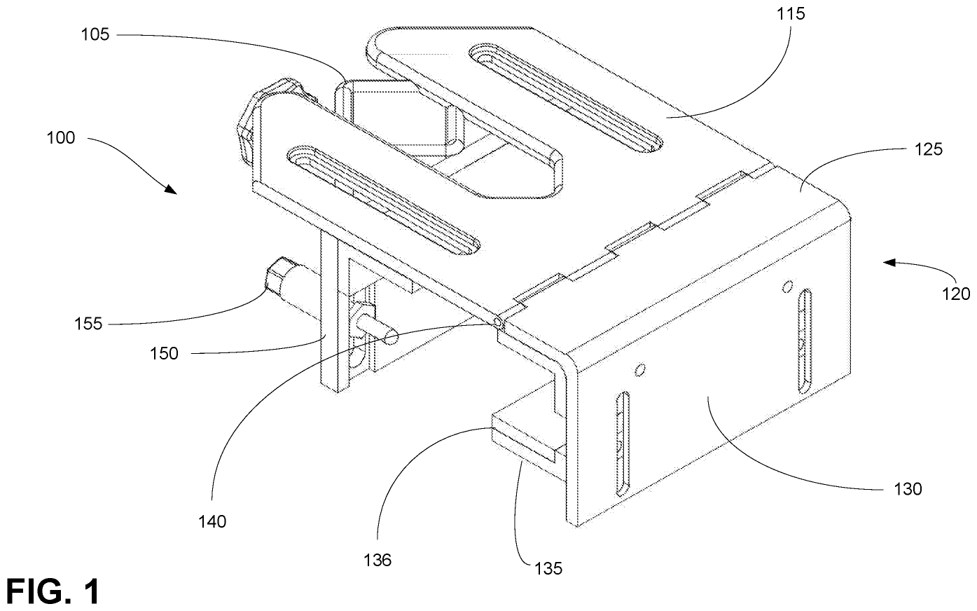

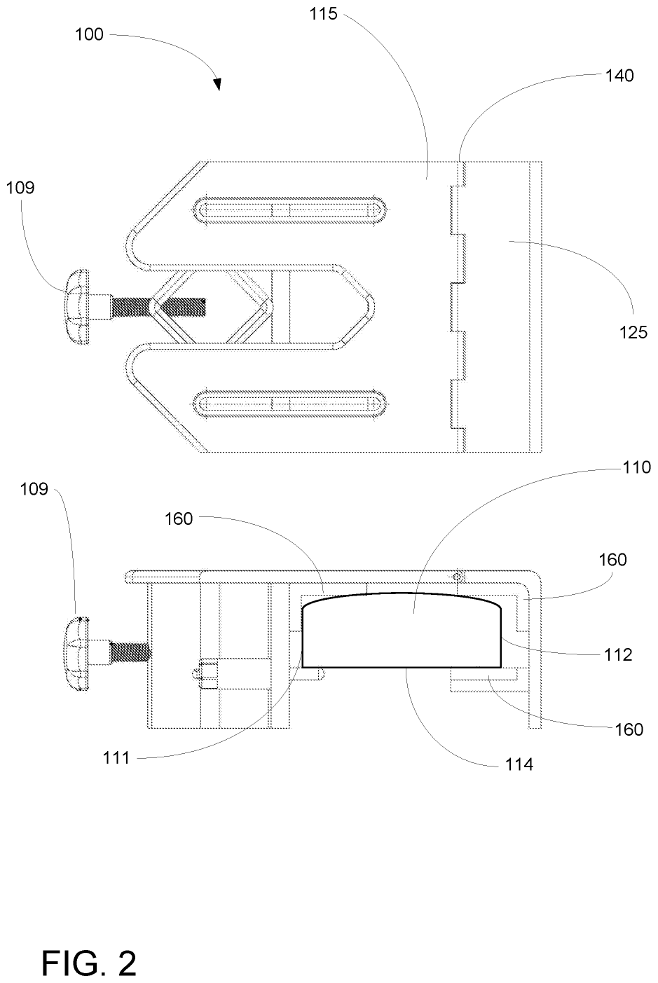

Referring to FIG. 1 and FIG. 2, an apparatus 100 for clamping onto a mount 110 is provided. The mount may have a first mount side 111 in a spaced apart parallel relationship with a second mount side 112. The first and second mount sides 111, 112 may be connected by a mount top 113 and a mount bottom 114. In some embodiments, the mount may be a top rail of a railing. The rail may be, for example, rectangular or square in cross section. Railings with curved sides may also be used as mounts. In certain embodiments, mounts may be custom built for use with the apparatus 100.

The apparatus 100 may include a holder 105 for holding items such as, without limitation, umbrella posts, flag posts, tiki torches, road signs, plant pots, and cups. The size and shape of the holder 105 may be based on the item to be held. For example, in some embodiments, the holder 105 may have any suitable size and shape for holding a pole. In certain embodiments, the holder 105 may have a circular cross section and in other embodiments, the holder 105 may have a cross-section with straight sides, such as a square or other polygonal shape, as shown in FIG. 1 and FIG. 2. The holder 105 may have an open bottom, a closed bottom or a partially open bottom.

The holder 105 may have any suitable type of side walls. For example, in some embodiments, the walls of the holder 105 may be solid, forming a tube. In certain embodiments, there may be spaces in the walls of the holder 105. For example, the side walls may be formed of a mesh or bands in some embodiments. In certain embodiments, the holder 105 may include a rod, plate or bar with bands attached to it. In some embodiments, the bands may be band clamps for securing the item to be held.

In some embodiments, the holder 105 may be able to accommodate items of different sizes and shapes. For example, the holder 105 may be able to hold a pole having a circular or a square cross-section and poles of different thicknesses. Any suitable way of tightening or securing the item in the holder 105 may be used. For example, in some embodiments, a set screw or a tightening bolt 109, as shown in FIG. 1 and FIG. 2, may be used for securing the item in the holder 105. In certain embodiments, the holder 105 may include other clamping systems to secure the item, such as band clamps. In some cases, bolts or screws may be used for tightening a wall of the holder 105 against the item to be held. In some embodiments, the holder 105 may be tapered down to a narrower cross-section along its length, allowing poles with a tapered thickness to be held securely.

The holder 105 may be formed of any suitable material, including, without limitation, metals such as aluminum and steel, plastic, and composites, including carbon fiber based materials and fibreglass.

Referring again to FIGS. 1 and 2, in some embodiments the apparatus 100 includes a first top piece 115 for sitting on a portion of the mount top 113. The first top piece 115 may be coupled to the holder 105 for holding the holder 105 over a side of the mount 110. In some embodiments, not shown, the holder 105 may be directly coupled to the first top piece 115 and in certain embodiments, as shown in FIG. 1, the holder 105 may be coupled to the first top piece 115 through other components.

In some embodiments, the holder 105 and the first top piece 115 may be mutually positioned so that when the apparatus 100 is in position on the mount 110, a portion of the first top piece 115 may rest on the mount top 113 and the holder 105 may be held away from a side of the mount 110. In certain embodiments, an extension (not shown) may be used to couple the holder 105 to the first top piece 115 in order to increase the clearance between a potential mount and the holder 105.

The holder 105 may be coupled to the first top piece 115 using any suitable connection. For example, and without limitation, the holder 105 may be coupled to the first top piece 115 using welds, screws, bolts, adhesives, or clamps. In some embodiments, the holder 105 and the first top piece 115 may be formed from a single piece of material.

The first top piece 115 may be of any suitable size and shape. For example, in some embodiments, the first top piece 115 may be shaped as a plate. The plate may be solid or have cut-outs for reducing weight or as an ornamental design. In certain embodiments, the first top piece 115 may be formed of one or more bars, plates, and rods. The first top piece 115 may be curved or flat.

In some embodiments, the first top piece 115 may have a length sufficient that when the apparatus 100 is installed on a mount 110, a portion of the first top piece 115 does not rest on the mount 110. The portion of the first top piece 115 that does not rest on the mount 110 may contribute to the clamping force of the apparatus 100. In some embodiments, the length of the first top piece 115 may be increased to increase the portion that hangs off the edge of the mount 110 and thus the clamping force.

The apparatus 100 may also include an end piece 120 that includes a second top piece 125 and a first side piece 130. The second top piece 125 may be adjacent to the first top piece 115.

The second top piece 125 may be coupled to the first side piece 130. Any suitable coupling may be used, including, without limitation, welds, bolts, screws, and adhesives. In some embodiments, the first side piece 130 and the second top piece 125 may be integrally formed as one piece.

The first side piece 130 may be positioned for extending towards the mount bottom 114. The first side piece 130 may be coupled to a bottom clamping piece 135 that is for extending along a portion of the mount bottom 114. The bottom clamping piece 135 may include a bearing end 136 distal to the first side piece 130 for bearing against the mount bottom 114.

The second top piece 125, the first side piece 130 and bottom clamping piece 135 may be of any suitable size and shape to extend the apparatus 100 from the mount top 113 to the mount bottom 114. For example, in some embodiments, the second top piece 125 may be sized and positioned so that at least a portion of the second top piece 125 sits atop the mount top 113 when the apparatus 100 is in position on the mount 110. The specific length and width of the second top piece 125, as well as the dimensions of all of the other components of the apparatus 100, may depend on the type and size of mount that the apparatus 100 is designed for. For example, the second top piece 125 may have a length such that the edge of the second top piece 125 that is adjacent to the first top piece 115 sits over a portion of the mount 110 when the apparatus 100 is in position over the mount 110. In embodiments where the mount 110 is a standard sized deck railing, the length of the second top piece 125 from the edge adjacent to the first top piece 115 to the first side piece 130 may be, for example, about 1″ to 2″.

Any of the second top piece 125, the first side piece 130 and the bottom clamping piece 135 may be shaped as, without limitation, plates, rods, bars or any combination thereof. They may be straight or curved. In some embodiments, they may include cut-outs. For example, the second top piece may have cut-outs to reduce the weight of the apparatus. In some embodiments, any of the second top piece 125, the first side piece 130 or the bottom clamping piece may be formed of a framework of bars or rods. For example, in some embodiments, the second top piece 125 may be a plate and the first side piece 130 may be a bar extending down from the second top piece 125. The bottom clamping piece may be, for example and without limitation, a plate or a prong. In some embodiments, one or more prongs may be used to extend between the spindles of the railing.

In certain embodiments, the bearing end 136 may be the only contact portion of the bottom clamping piece 135. For example, the bottom clamping piece 135 may be angled upwards from the first side piece 130 or curved around the mount bottom 114 to avoid contact with the mount bottom 114 except at the bearing end 136. Similarly, the first side piece 130 may be curved around the second mount side 112. In some embodiments, the first side piece 130 and the bottom clamping piece 135 may be integrally formed as a single piece.

In some embodiments, as shown in FIG. 1, the bottom clamping piece 135 may be adjustably coupled to the first side piece 130 for adjusting the position of the bottom clamping piece 135 to position the bearing end 136 against the mount bottom 114. Any suitable coupling mechanism may be used that allows movement of the bottom clamping piece 135 between a position wherein the bearing end 136 is engaged with the mount bottom 114 and a position where the bearing end 136 is positioned away from the mount bottom 114. In some embodiments, the coupling mechanism may be one that allows for translational motion of the bottom clamping piece 135 relative to the first side piece 130 so that the bottom clamping piece 135 may move up and down. For example, and without limitation, the bottom clamping piece 135 may be slidably coupled to the first side piece 130. A portion of the bottom clamping piece 135 may be engaged in a slot or groove of the first side piece 130, allowing the bottom clamping piece 135 to slide up and down along the slot. For example, and without limitation, bolts or threaded studs may be screwed into threaded holes in the end of the bottom clamping piece 135. The bolts or threaded studs may pass through slots in the first side piece 130.

Any suitable locking mechanism may be used to lock the adjustably coupled bottom clamping piece 135. For example, in embodiments using bolts in threaded holes, the bolts may be tightened against the first side piece 130 to hold the bottom clamping piece 135 in position. In some embodiments, nuts may be used with, for example, threaded studs protruding from the bottom clamping piece 135 and through a slit in the first side piece 130 to lock the bottom clamping piece 135 in position.

In certain embodiments, the bottom clamping piece 135 may be hingedly coupled to the first side piece 130, allowing the bottom clamping piece 135 and bearing end 136 to be swung into position against the mount bottom 114. A suitable locking mechanism, as will be known in the existing art, may be used to hold the bottom clamping piece 135 in position.

In some embodiments, the first side piece 130 may be adjustably coupled to the second top piece 125. The coupling may be through known techniques allowing for translational motion or rotational motion, as discussed previously for adjustable couplings between the first side piece 130 and the bottom clamping piece 135. The bearing end 136 may be moved into position against the mount bottom 114 by moving the first side piece 130 relative to the second top piece 125.

The apparatus 100 may further include a hinge 140 coupling the first top piece 115 to the second top piece 125. The hinge 140 may transfer a first downwards force applied at the holder 105 to an upwards force at the bearing end 136 and a second downwards force at a portion of the second top piece 125 and may generate a twisting force on the mount 110, causing the apparatus to clamp onto the mount 110. The twisting force may be due to one of the portion of the second top piece 125 and the bearing end 136 being closer than the other to an axis which is perpendicular to the second top piece 125 and passes through the hinge 140 when the apparatus 100 is installed on the mount 110. The clamping force may increase when an item is placed in the holder 105, such that heavier items may generate a stronger clamping force. In some embodiments, the clamping force may be proportional to the downwards force generated at the holder 105. In certain embodiments, the weight of the portion of the first top piece 115 that overhangs the mount 110 may also contribute to the downwards force transferred by the hinge 140.

In some embodiments, the first top piece 115 may have a pivot point at a point of contact with the mount 110. The pivot point may be, for example, at the point of contact between the mount 110 and the first top piece 115 closest to the first mount side 111. Placing an item in the holder 105 may create a downwards force at the holder 105 and cause the first top piece 115 to exert an upwards force at the hinge 140 due to pivoting at the pivot point. The upwards force exerted by at the hinge 140 acts on the edge of the second top piece 125, which may cause the bearing end 136 to exert a force upwards against the mount bottom 114 as well as a force moment or a twisting force. In certain embodiments, there may be a second pivot point, this one at a contact point of the portion of the second top piece 125 and the mount 110, which may be at the point of contact closest to the second mount side 112. The second top piece 125 may exert a downwards force on the mount 110 at the second pivot point and a twisting force may be generated between the bearing end 136 and the second pivot point. The twisting force may be due to a lateral offset between the portion of the second top piece 125 and the bearing end 136 such that one of the portion of the second top piece 125 and the bearing end 136 is closer than the other to an axis perpendicular to the second top piece 125 and passing through the hinge 140 when the apparatus 100 is installed on the mount 110. The forces and moments exerted by the second top piece 125 and the bearing end 136 may clamp the apparatus to the mount 110.

In some embodiments, the hinge 140 and the bearing end 136 may have an axis that passes through both the hinge 140 and the bearing end 136 and that is perpendicular to the second top piece 125. In such embodiments, the hinge 140 and the bearing end 136 may be laterally aligned above and below the mount 110. Having this alignment may ensure an offset between the bearing end 136 and the portion of the second top piece 125 that pushes down on the mount in response to a load at the holder 105. Having the bearing end 136 aligned with the hinge 140 may also allow, in some embodiments, for easier positioning of the bearing end 136 on the mount bottom 114. For example, in embodiments where the hinge 140 and the bearing end 136 are aligned as discussed above, the bearing end 136 may be positioned along the mount bottom 114 as desired by a user. In these embodiments, the positioning the bearing end 136 along the mount bottom 114 may result in the hinge 140 being positioned over the mount 110 due to the alignment.

In some embodiments, if the railing has spindles or a pane extending down from the bottom of the railing that limits how far in the bearing end 136 can reach, the bearing end 136 may be positioned close to an edge of the mount bottom 114. If the hinge 140 is offset from the bearing end 136 such that it is closer to the first side piece 130 than the bearing end 136 is, the hinge may be positioned off of the mount 110. In some embodiments, the hinge 140 may be offset from the bearing end 136 such that the bearing end 136 is closer to the first side piece 130 than the hinge 140 is. In these embodiments, if the mount 110 allows for the bearing end 136 to reach in along the mount bottom 114, the hinge position 140 may limit how far in the bearing end 136 may be moved in order to keep the hinge 140 positioned over the mount 110.

In some embodiments, the forces exerted by the apparatus 100 on the mount 110 may be distributed over portions of the surface area of the apparatus rather than at a point or along a line.

In some embodiments, the twisting force exerted by the bearing end 136 and the second top piece 125 on the end of the mount 110 may be oriented clockwise in the view shown in FIG. 2. This is opposite in direction to the force moment created by the weight at the holder 105 and/or the weight of the overhanging portion of the first top piece 115. Exerting opposing moments of force may be advantageous in some embodiments by reducing the overall force moment acting on the structure supporting the mount 110 while the localized forces from the bearing end 136 and the second top piece 125 on the end of the mount 110 may clamp the apparatus 100 to the mount 110.

Any suitable hinge or hinged connection may be used. In some embodiments, the mutually adjacent edges of the first top piece 115 and the second top piece 125 may form alternating knuckles that interlock and are pinned together. Any suitable number of knuckles may be used. The knuckles may be interlocked tightly or may have gaps between them. For example, in some embodiments, there may only be knuckles at the ends of the mutually adjacent edges of the first and second top pieces 125, 115. In other embodiments, knuckles may run along the length of the mutually adjacent edges of the first and second top pieces 115, 125. The knuckles may be pinned using any suitable pinned connection. For example, a single pin may pass all of the knuckles. In some embodiments, separate knuckle pairs or groups may be separately pinned.

In certain embodiments, external hinges may be used. Any suitable type and number of external hinges may be used. For example, and without limitation, piano or continuous type hinges, butt hinges, heavy duty butterfly hinges, and tee hinges may be used.

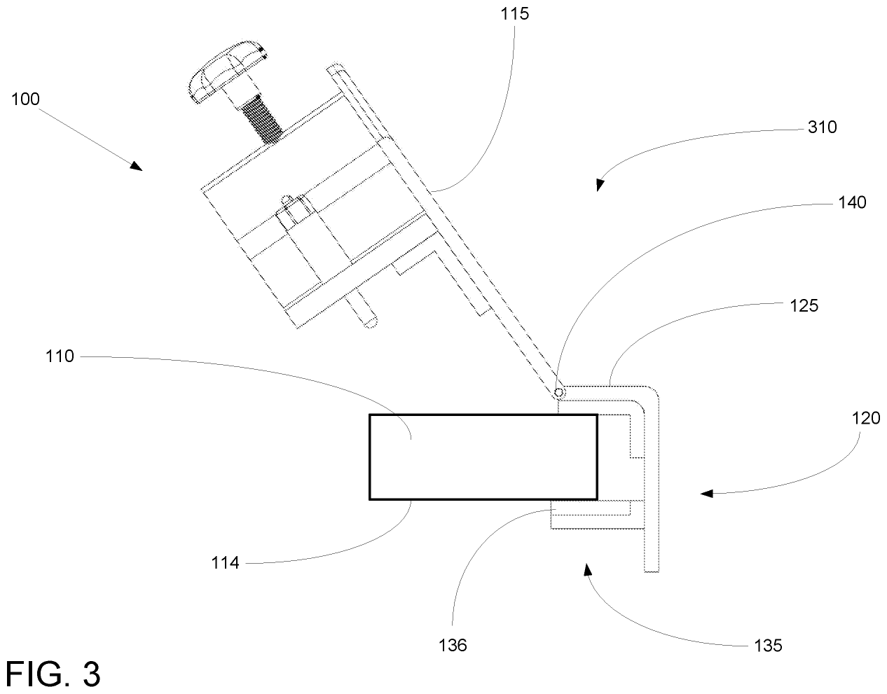

Referring to FIG. 3, in some embodiments, the hinged connection 310 may allow rotation of the first top piece 115 relative to the second top piece 125 in either direction when the apparatus 100 is in position on the mount 110. Allowing rotation of the first top piece 115 in a direction such that the first top piece 115 lifts away from the mount 110 while the second top piece 125 is in position on the mount 110 may be advantageous in allowing easy installation and removal of the apparatus 110 onto and from the mount 110. The end piece 120 and the clamping piece 135 may be positioned around one side of the mount 110 and the first top piece 115 may then be lowered into place. Without a hinge allowing rotation in this direction, placement of the apparatus 100 around the mount 110 may be difficult.

Allowing further rotation of the first top piece 115 in a direction towards the mount 110 when both the first top piece 115 and the second top piece 125 are resting on the mount 110 is advantageous in allowing the generation of a force pushing the bearing end 136 against the mount bottom 114 and the twisting force exerted by the second top piece 125 and the bearing end 136 that is opposite in direction to the force moment created by the weight of the item in the holder 105 and the portion of the first top piece 115 not resting on the mount top 113. In some embodiments, the clamping generated due to the hinged connection may be stronger than the clamping that would be generated if there was no hinged connection.

The hinge 140 may be positioned at any suitable position between the first top piece 115 and the second top piece 125 such that the hinge 140 may be positioned over the mount 110 when the apparatus is installed on the mount 110. In some embodiments, hinge 140 may be positioned closer to the first mount side 111 and in some the hinge 140 may be positioned closer to the second mount side 112. The dimensions of the second top piece 125 and the first top piece 115 together may determine the position of their mutually adjacent edges, and thus the hinge 140, over the mount 110. For example, in some embodiments, the hinge 140 may be closer to the first mount side 111 than the second mount side 112. In certain embodiments, the hinge 140 may be closer to the second mount side 112 than the first mount side 111. If the overall length of the apparatus 110 is similar in these embodiments, the position of the hinge 140 may vary due to changes in the length of each of the first top piece 115 and the second top piece 125. The position of the hinge 140 may be set for a specific apparatus 100 based on the application the specific apparatus 100 is designed for.

In some embodiments, the apparatus 100 may comprise a second side piece 150 extending down from the first top piece 115. In certain embodiments, the second side piece 150 may be pushed against the mount 110 when the apparatus 100 is placed in position. In some embodiments, the second side piece 150 may be adjustably coupled to the first top piece 115 for moving the second side piece 150 along a portion of the length of the first top piece 115 to fit the apparatus 100 on mounts of different sizes. Any suitable adjustable coupling allowing movement of the second side piece 150 along a portion of the length of the first top piece 115 may be used. For example, in some embodiments, pieces extending from the second side piece 150 may be slidably engaged in slots in the first top piece 115. The pieces extending from the second side piece 150 may be, for example and without limitation, integral parts of the second side piece or external pieces coupled to the second side piece 150, such as bolts. In some embodiments, a tightening mechanism, such as tightening nuts, may be used to lock the second side piece 150 into position. In certain embodiments, bolts may be screwed into threaded holes in the second side piece 150 and tightened against the first top piece 115 to hold the second side piece 150 in position.

In some embodiments, a spring may be used to hold the second side piece 150 in position against the first mount side 111. The spring may be disengaged or pulled back when installing or removing the apparatus 100 from the mount 110. After engaging the bearing end 136 against the mount bottom 114 and moving the top piece 115 into position over the mount 110, the spring may be used to push the second side wall 150 against the mount 110.

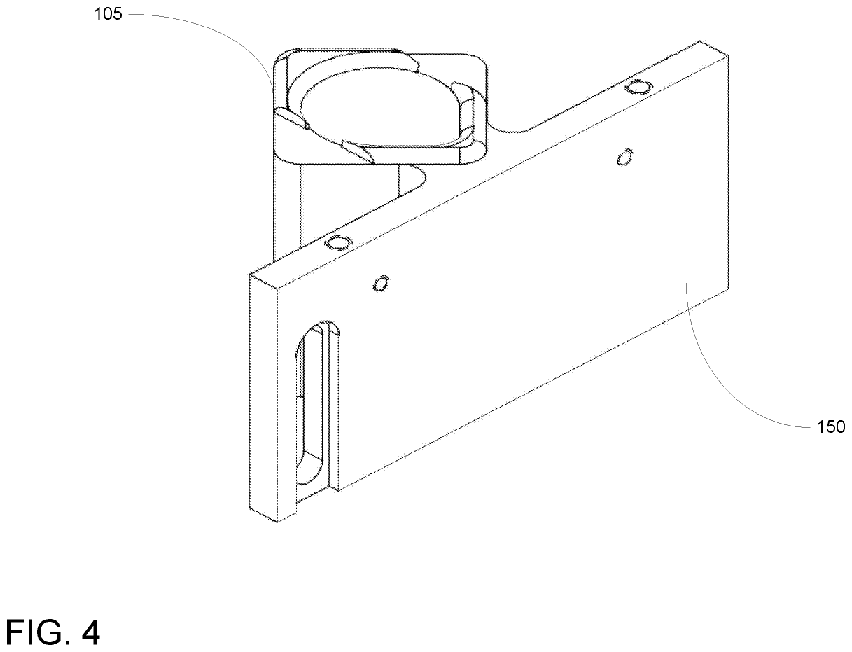

In some embodiments, the second side piece 150 may be attached to the holder 105, as shown in FIG. 4. Referring again to FIG. 1, the coupling between the holder 105 and the first top piece 115 may be through the second side piece 150. In some embodiments, where the second side piece 150 is adjustably coupled to the first top piece 115, moving the second side piece 150 may result in movement of the holder 105. In certain embodiments, the first top piece 115 may have a slot to accommodate movement of the holder 105.

Any suitable coupling may be used to attach the holder 105 to the second side piece 150. In some embodiments, the coupling may include, for example and without limitation, a weld, bolts, screws, clamps, and adhesives. In certain embodiments, the holder 105 and the second side piece 150 may be integrally formed as one component.

The second side piece 150 may be of any suitable shape for being positioned adjacent to the first mount side 111. For example, in some embodiments, the second side piece 150 may be shaped as a solid plate or bar. In some embodiments, the second side piece 150 may have cut-outs. In certain embodiments, the second side piece may be formed as a frame of one or more bars, rods or plates.

In some embodiments, the apparatus 100 may include a second bottom piece 155 coupled to the second side piece 150 at a location closer to the distal end of the second side piece 150 than to the end coupled to the first top piece 115, wherein the second bottom piece 155 is for positioning adjacent to the mount bottom 114 to limit rotation of the first top piece 115 around the hinge 140. In certain embodiments, the second bottom piece 155 may be for securing the apparatus 100 in position by reducing the possibility of having the holder 105 and first top piece 115 rotating around the hinge, with the first top piece 115 lifting away from the mount 110 and towards the second top piece 125. For example, in some embodiments, wind may push an umbrella held in the holder 105 in a direction towards the second top piece 115. The second bottom piece 155 may secure the first top piece 115 and may reduce the possibility of the first top piece 115 lifting up and rotating towards the second top piece 125.

Positioning of the second bottom piece 155 adjacent to the mount bottom 114 may be reversible, meaning that the second bottom piece 155 may be moved into an engaged position or a disengaged position with the mount 110. An engaged position is a position wherein a portion of the second bottom piece 155 is positioned directly below the mount 110 and a disengaged position is a position where second bottom piece 155 is clear of the mount bottom 114 such that the first top piece may be swung upwards without the second bottom piece 155 touching the mount bottom 114.

In some embodiments, the second bottom piece 155 and the second side piece 150 may have a mutually fixed relationship, such that the second bottom piece 155 and the second side piece 150 move in unison and have fixed positions relative to each other. For example, in some embodiments, the second bottom piece 155 may be rigidly fixed to the second side piece 150. The second side piece 150 may be adjustably coupled to the first top piece 115. Moving the second side piece 150 into position against the mount 110 during installation of the of the apparatus 100 onto the mount 110 may result in the second bottom piece 155 running along a portion of the mount bottom 114.

In certain embodiments, the second bottom piece 155 may be movably coupled to the second side piece 150 such that the second bottom piece 155 may be moved relative to the second side piece 150. For example, in some embodiments, once the second side piece 150 is in position adjacent to the first mount side 111, the second bottom piece 155 may be moveable laterally relative to the second side piece 150 such that it may be pushed from a position away from the mount bottom 114 to a position underneath the mount bottom 114. It may be in contact with the mount bottom 114 or slightly separated from the mount bottom 114. In some embodiments, the second bottom piece 155 may be locked into position using, for example and without limitation, a set screw, a nut, or any other suitable locking mechanism.

In certain embodiments, the second bottom piece 155 may be spring loaded. During installation or removal of the apparatus 100, the second bottom piece 155 may be pulled back, compressing the spring, to allow the second side piece 150 to be positioned. Once the second side piece 150 is positioned, the second bottom piece 155 may be released, allowing the spring to push the second bottom piece 155 into an engaged position.

In some embodiments, the second bottom piece 155 may be hingedly coupled to the second side piece 150, allowing the second bottom piece 155 to be swung into position against the mount bottom 114. The second bottom piece 155 may be lockable into position against the mount bottom 114 using any suitable mechanism. In certain embodiments, a spring may be used to hold the second bottom piece 155 in position against the mount bottom 114.

The second bottom piece 155 may be of any suitable size and shape for moving into position adjacent to the mount bottom 114 and limiting rotation of the first top piece 115. For example, in some embodiments, the second bottom piece 155 may be shaped as a rod or a pin for being slid or pushed into position underneath the mount bottom 114. In certain embodiments, the second bottom piece may be shaped as a plate or bar.

In some embodiments, the second bottom piece 155 may be lockable into position using an external locking device, such as a padlock. For example, in some embodiments, the second bottom piece 155 may be a rod that may be moved laterally from the bottom of the second side piece 150 to an engaged position under the mount bottom 114. The second bottom piece 155 may have a hole positioned between the second side piece 150 and the mount 110 when the second bottom piece 155 is in an engaged position. A lock, such as a padlock, may be used with the hole to lock the second bottom piece 155 in the engaged position, which may limit removal of the apparatus 100. This may be advantageous in situations where the apparatus 100 is used in public locations, such as patios in restaurants or for road signs.

The various components of the apparatus 100 may have any suitable dimensions based on the size of the holder 105 and the mount 110. For example and without limitation, the width of the first and second top pieces 115 and 125 may be about 6 inches, their combined length may be about 8.5 to 9 inches with the second top piece 125 accounting for about 1.5 to 2 inches of the combined length. The first side piece 130 may be about 3 to 3.5 inches long (with length representing the distance it will extend along the second side wall 112 of the mount 110 when installed). The bottom clamping piece 135 may be about 1.5 to 2 inches long (with length being the distance the bottom clamping piece 135 will extend along the mount bottom 114). The second side piece 150 may be about 3 to 3.5 inches long. The above dimensions are for some embodiments and in no way limit the dimensions of components in other embodiments.

The thicknesses of the components of the apparatus 100 may be based on strength and weight considerations. In some embodiments, such as an apparatus 100 for use with a medium sized backyard umbrella, steel plates with thicknesses of about a quarter inch may be used for the various components of the apparatus 100. These thicknesses may be increased or decreased depending on the potential weight of the items the particular apparatus may be designed for, the materials being used and the size of the mount.

The components of the apparatus 100 may be formed of any suitable or combination of suitable materials. Materials such as, for example and without limitation, metals including aluminum and steel, plastic, wood and composites, including carbon-fiber based materials and fibreglass, may be used.

Referring again to FIG. 1, in some embodiments, any of the first and second top pieces 115, 125, the first and second side pieces 130, 150, the bottom clamping piece 135 and the bearing end 136 may include pad pieces 160. In certain embodiments, the pad pieces 160 may be formed of a softer material than the component it is attached to, thereby reducing the possibility of damage, such as scratches, to the mount 105. The pad pieces 160 may also, in some embodiments, be formed of a material with greater grip than the components they are attached to. The pad pieces 160 may be coupled to components of the apparatus 100 to reduce direct contact between these components and the mount 110. In certain embodiments, the pad pieces 160 may also determine the pivot points of the first and second top pieces 115, 125 by limiting the area of contact between the first and second top pieces 115, 125 and the mount 110.

Any suitable coupling technique may be used to attach the pad pieces 160 to the other components of the apparatus 100. For example, the pad pieces 160 may be attached to the other components of the apparatus 100 using, without limitation, screws, bolts, rivets or adhesives.

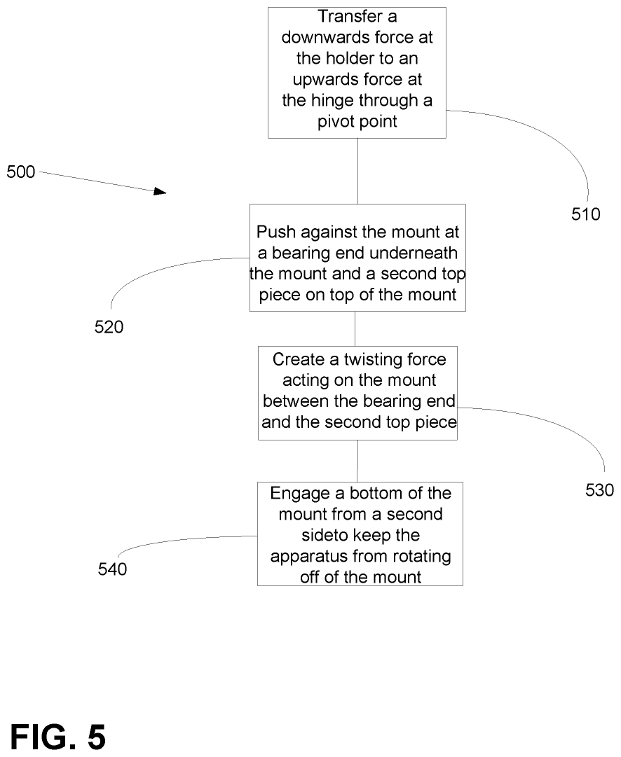

Referring to FIG. 5, an embodiment of a method 500 for coupling a holder to a mount, such as and without limitation, a top rail of a deck railing, is provided. At box 510, an upwards force is exerted on a hinge coupling a first top piece and a second top piece of a clamping apparatus. The first top piece is also coupled to the holder at an end distal to the hinge. The upwards force is generated by transferring a force at the holder generated by weights of at least one of the holder, the item and a portion of the first top piece, around a pivot point and to an upwards force pushing against the hinge.

At box 520, forces are exerted on the mount that push down at a top surface of the mount and up at a bottom surface of the mount by positioning a bearing end of a bottom clamping piece underneath the mount. The bottom clamping piece may be coupled to the second top piece through a first side piece, such that the upwards force at the hinge pulling on an end of the second top piece causes the second top piece, the first side piece and the bottom clamping piece to experience a first twisting force. This first twisting force may cause a portion of the second top piece to push against the top of the mount and the bearing end to push against the bottom of the mount

At box 530, a second twisting force that acts on the mount is generated by positioning the second top piece and the bearing end such that the portion of the second top piece that pushes against the top is laterally offset from the bearing end. The offset is such that one of the portion of the second top piece and the bearing end are closer than the other to an axis perpendicular to the second top piece and passing through the hinge when the apparatus is installed on the mount. The second twisting force is opposite in orientation to a force moment generated on the mount by the load at the holder.

At box 540, the first top piece may be secured to reduce the possibility of the first top piece lifting off the mount and rotating towards the second top piece. The first top piece may be secured by positioning a second bottom piece adjacent to the bottom of the mount when the apparatus is in an installed position. The second bottom piece may be coupled to the first top piece and may be moveable for moving into position during the installation process.

The components described in the method above may be similar to the components of the apparatus 100 discussed earlier.

The terminology used herein is for the purpose of describing particular embodiments only and is not intended to be limiting. Accordingly, as used herein, the singular forms “a”, “an” and “the” are intended to include the plural forms as well, unless the context clearly indicates otherwise. It will be further understood that the terms “comprises” and “comprising,” when used in this specification, specify the presence of one or more stated features, integers, steps, operations, elements, and components, but do not preclude the presence or addition of one or more other features, integers, steps, operations, elements, components, and groups.

It is contemplated that any part of any aspect or embodiment discussed in this specification can be implemented or combined with any part of any other aspect or embodiment discussed in this specification.

While particular embodiments have been described in the foregoing, it is to be understood that other embodiments are possible and are intended to be included herein. It will be clear to any person skilled in the art that modifications of and adjustments to the foregoing embodiments, not shown, are possible.

1. An apparatus for coupling to a mount that has a first mount side in a spaced apart relationship with a second mount side, the first and second mount sides connected by a mount top and a mount bottom, the apparatus comprising:
(a) a holder for holding an item;
(b) a first top piece for resting on a portion of the top of the mount, the first top piece coupled to the holder for holding the holder over a side of the mount;
(c) an end piece comprising a second top piece and a side piece, the second top piece adjacent to the first top piece and coupled to the side piece, wherein the side piece is positioned for extending towards the mount bottom;
(d) a bottom clamping portion coupled to the side piece for extending along a portion of the mount bottom, wherein the bottom clamping portion has a bearing end distal to the side piece for bearing against the mount bottom; and
(e) a hinge coupling the first top piece to the second top piece, wherein the hinge is for transferring a first downwards force applied at the holder to an upwards force at the bearing end and a second downwards force at a portion of the second top piece and generating a twisting force on the mount due to one of the portion of the second top piece and the bearing end being closer than the other to an axis that is perpendicular to the second top piece and passes through the hinge when the apparatus is installed on the mount, causing the apparatus to clamp onto the mount.

2. The apparatus of claim 1 further comprising a second side piece extending down from the first top piece.

3. The apparatus of claim 1 wherein the second side piece is adjustably coupled to the first top piece for moving the second side piece along a portion of the length of the first top piece for fitting the apparatus on mounts of different sizes.

4. The apparatus of claim 1 wherein bottom clamping piece is adjustably coupled to the first side piece for adjusting the position of the bottom clamping piece to position the bearing end against the mount bottom.

5. The apparatus of claim 2 further comprising a second bottom piece coupled to the second side piece at a location closer to the distal end of the second side piece than to the end coupled to the first top piece and positionable adjacent to the mount bottom when the apparatus is installed on the mount, for limiting rotation of the first top piece around the hinge.

6. The apparatus of claim 1 wherein the hinge and the bearing end have an axis that passes through both the hinge and the bearing end and that is perpendicular to the second top piece.

7. The apparatus of claim 1 wherein the holder is sized and shaped to hold a pole.

8. The apparatus of claim 1 wherein the first side piece is adjustably coupled to the second top piece for adjusting the position of the first side piece relative to the top piece.

9. A method for coupling a holder for holding an item to a mount, the method comprising:
(a) exerting an upwards force on a hinge coupling a first top piece and a second top piece of a clamping apparatus, the first top piece also coupled to the holder at an end distal to the hinge, by transferring a force at the holder generated by weights of at least one of the holder, the item and a portion of the first top piece, around a pivot point where the first top piece rests on the mount and to the upwards force pushing against the hinge;
(b) exerting forces pushing down at a top surface of the mount and up at a bottom surface of the mount by positioning a bearing end of a bottom clamping piece underneath the mount, the bottom clamping piece coupled to the second top piece through a first side piece, such that the upwards force at the hinge pulling on an end of the second top piece causes the second top piece, the first side piece and the bottom clamping piece to experience a first twisting force, causing a portion of the second top piece to push against the top of the mount and the bearing end to push against the bottom of the mount; and
(c) generating a second twisting force acting on the mount by positioning the second top piece and the bearing end such that the portion of the second top piece that pushes against the top is laterally offset from the bearing end with one of the portion of the second top piece and the bearing end being closer than the other to an axis perpendicular to the second top piece and passing through the hinge when the apparatus is installed on the mount, wherein the second twisting force is opposite in orientation to a force moment generated on the mount by the weight at the holder.

10. The method of claim 9 further comprising securing the first top piece from lifting off the mount by positioning a second bottom piece adjacent to the bottom of the mount when the apparatus is in an installed position.
